(19) United States
(12) Patent Application Publication
(10) Pub. No.: US 2006/0161751 A1
(43) Pub. Date: Jul. 20, 2006

(54) Virtual memory management infrastructure for monitoring deltas and supporting undo versioning in a paged memory system

(76) Inventors: John William Barrs, Austin, TX (US); Michael Wayne Brown, Georgetown, TX (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(21) Appl. No.: 11/037,000

(22) Filed: Jan. 18, 2005

(51) Int. Cl. G06F 12/00

(52) U.S. Cl. 711/170

(57) ABSTRACT

An improved method, apparatus, and computer instructions for writing a page of data in response to receiving a request to write the page in the paged memory system. Creating a version of the page of data in response to receiving the request to write the page in the paged memory system, and associating a version identifier with the version of the page.

### CROSS REFERENCE TO RELATED APPLICATIONS

The present invention is related to the following patent applications: entitled “Method and Apparatus for Dimensional Data Versioning and Recovery Management”, Ser. No. ______, attorney docket no. AUS920040309US1; entitled “Method and Apparatus for Data Versioning and Recovery Using Delta Content Save and Restore Management”, Ser. No. ______, attorney docket no. AUS920040638US1; entitled “Platform Infrastructure to Provide an Operating System Based Application Programming Interface Undo Service”, Ser. No. ______, attorney docket no. AUS920040639US1; entitled “Infrastructure for Device Driver to Monitor and Trigger Versioning for Resources”, Ser. No. ______, attorney docket no. AUS920040641US1; entitled “Method and Apparatus for Managing Versioning Data in a Network Data Processing System”, Ser. No. AUS920040642US1, attorney docket no. ______; entitled “Heap Manager and Application Programming Interface Support for Managing Versions of Objects”, Ser. No. ______, attorney docket no. AUS920040643US1; entitled “Method and Apparatus for Marking Code for Data Versioning”, Ser. No. ______, attorney docket no. AUS920040644US1; and entitled “Object Based Access Application Programming Interface for Data Versioning”, Ser. No. ______, attorney docket no. AUS920040645US1 filed even date hereof, assigned to the same assignee, and incorporated herein by reference.

### BACKGROUND OF THE INVENTION

1. Technical Field

The present invention provides a method, apparatus, and computer instructions for managing data in a paged memory system. A virtual memory manager creates a version of a page in response to receiving a request to write to a page. A version identifier is associated with the version of the page. Prior versions of the page may be returned to physical memory at a later time if a request for the page includes an argument, such as a version identifier.

2. Description of Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means. As the program logic of an application progresses, situations often arise in which the program state and the content of the data storage elements need to be reset to a prior state. This prior state may be an arbitrary state selected by the user or programmatically by an application. Mechanisms for incrementally saving and resetting data to a prior known state are present in many applications.

Currently available mechanisms are found in applications, such as word processors, for resetting or rolling back data to a previous state. A word processor may allow a user to undo changes to a document, such as deletions, insertions, or formatting changes.

A significant problem with existing mechanisms is that they are prone to inefficiencies and require explicit management by the application programmer or end user. Additionally, different applications may provide for different ways to save and restore changes. As a result, the behavior of a restore function in one application may be different from this type of function in another application. As 6 result, a user using one application may be unable to restore data to the same extent as with another application. Therefore, it would be advantageous to have an improved method, apparatus, and computer instructions for data versioning and recovery management.

### SUMMARY OF THE INVENTION

The present invention provides an improved method, apparatus, and computer instructions for writing a page of data in response to receiving a request to write the page in the paged memory system. Creating a version of the page of data in response to receiving the request to write the page in the paged memory system, and associating a version identifier with the version of the page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system that may be Implemented as a server in accordance with a preferred embodiment of the present invention;

FIG. 3 is a diagram illustrating components used in a versioning system is depicted in accordance with a preferred embodiment of the present invention;

FIG. 4 is a diagram illustrating components used to provide an undo service in accordance with a preferred embodiment of the present invention;

FIG. 5 is a diagram illustrating a device driver used to save state information in accordance with a preferred embodiment of the present invention;

FIG. 6 is a diagram illustrating a virtual memory manager used to save state information in accordance with a preferred embodiment of the present invention;

FIG. 7 is a flowchart of a process for storing a version of data in accordance with a preferred embodiment of the present invention;

FIG. 8 is a flowchart of a process for restoring a prior version of data in accordance with a preferred embodiment of the present invention;

FIG. 9 is a flowchart of a process in a device driver for saving state information in accordance with a preferred embodiment of the present invention;

FIG. 10 is a flowchart of a process in a device driver for saving state information in accordance with a preferred embodiment of the present invention;

FIG. 11 is a flowchart of a process in a device driver for saving state information in accordance with a preferred embodiment of the present invention;

FIG. 12 is a flowchart of a process in a device driver for restoring state information in accordance with a preferred embodiment of the present invention;

FIG. 13 is a flowchart of a process in a virtual memory manager for storing versions of pages in accordance with a preferred embodiment of the present invention; and

FIG. 14 is a flowchart of a process in a virtual memory manager for retrieving pages from a swap file in accordance with a preferred embodiment of the present invention.

### DETAILED DESCRIPTION OF THE PREFERRED EMBODIMENT

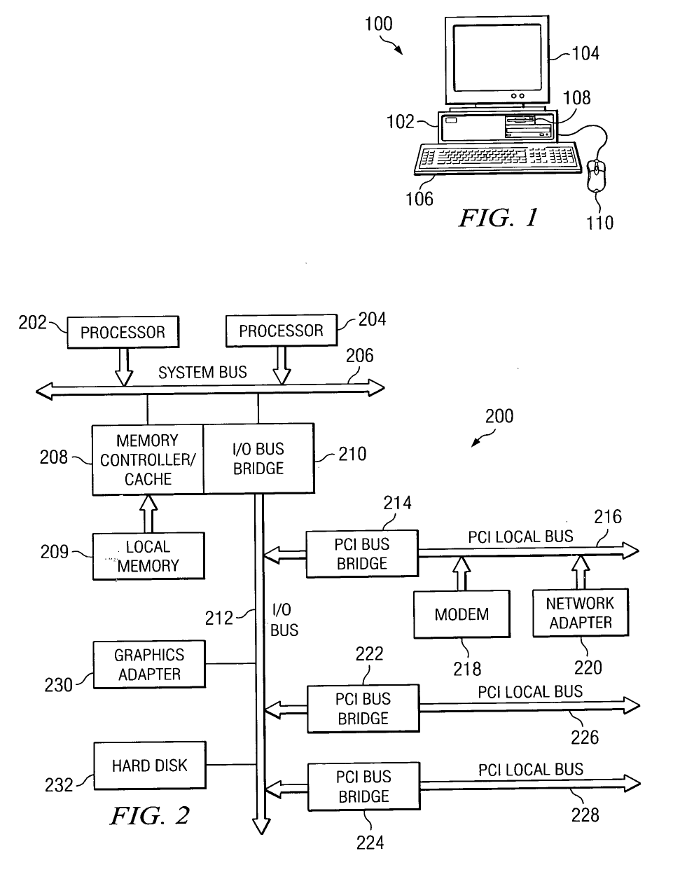

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCL expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 also may be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

The present invention provides an improved method, apparatus, and computer instructions for managing versions of data in a data processing system. In particular, the present invention provides a platform structure for a versioning or undo service. This service is accessed by applications through an application programming interface. (API) layer. This layer is located within an operating system in these examples.

In this manner, different applications may make calls to restore data to a prior version using a single interface provided through the operating system. In addition to storing versions of data in the memory and providing an ability to restore the data, the mechanism of the present invention also provides an ability to store and restore other information that may be necessary for an application to use the data in the memory in its prior state.

For example, the mechanism of the present invention includes storing state information used by device drivers and hardware devices as well as providing versioning for pages located in swap files. The mechanism of the present invention includes a system to restore this type of information to a state corresponding to the data in memory.

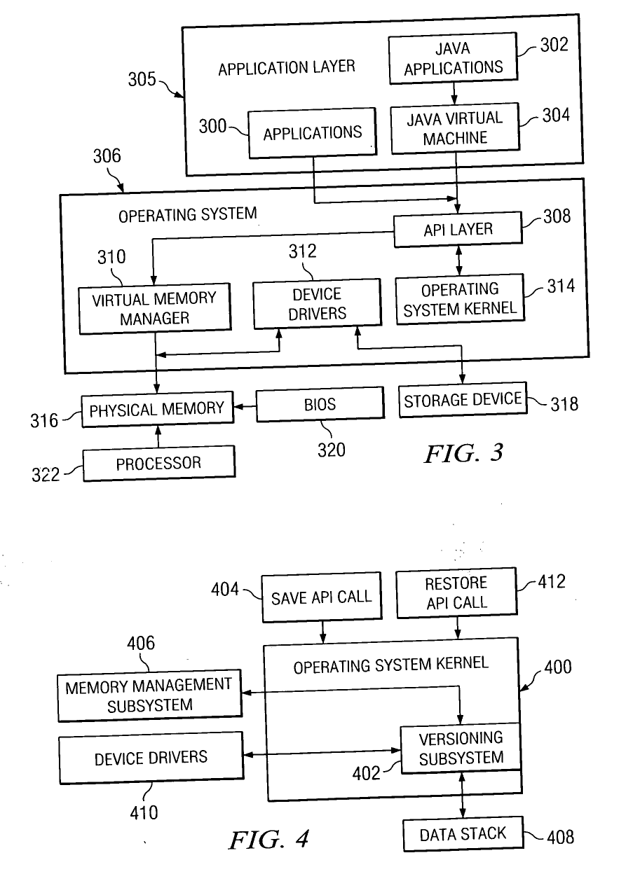

With reference to FIG. 3, a diagram illustrating components used in a versioning system is depicted in accordance with a preferred embodiment of the present invention. These components are examples of components that may be found in a data processing system, such as data processing system 200 in FIG. 2.

In this example, applications 300, Java applications 302, and Java virtual machine 304 are located in an application layer 305. Applications 300, and Java virtual machine 304 may send requests or calls to operating system 306. These calls are handled through API layer 308 within operating system 306. An API is a language and message format used by an application program to communicate with the operating system. APIs are implemented by writing function calls in the program, which provide the linkage to the required subroutine for execution.

Java applications 302 make calls to Java virtual machine 304. A Java virtual machines is a Java interpreter. The Java virtual machine is software that converts the Java intermediate language, such as bytecodes, into machine language and executes the machine language. A Java virtual machine is typically incorporated into a Web browser to execute Java applets. A Java virtual machine also is installed in a Web server to execute server-side Java programs. A Java virtual machine also can be installed in a client machine to run stand-alone Java applications.

Operating system 306 also includes virtual memory manager 310, device drivers 312, and operating system kernel 314. Virtual memory manager 310 simulates more physical memory than actually exists in a data processing system. This component breaks up a program into small segments, called “pages,” and brings as many pages from a storage device in to physical memory that fit into a reserved area for that program. When additional pages are required, virtual memory manager 310 makes room for these pages by swapping them to the storage device. This component keeps track of pages that have been modified so that they can be retrieved when needed again.

Device drivers 312 are programs that link the operating system to a peripheral device. Device drivers 312 understand the language and characteristics for different hardware devices. Device drivers 312 contain the precise machine language necessary to perform the functions requested by an application. A kernel is a part of an operating system that resides in memory at all times and provides the basic services. This component is the part of the operating system that is closest to the hardware and may activate the hardware directly or interface to another software layer that drives the hardware.

Virtual memory manager 310 and device drivers 312 provide access to data and physical memory 316. For example, operating system 306 may save data from physical memory 316 to storage device 318 through calls to device drivers 312. Other devices that may access physical memory 316 include basic input/output system (BIOS) 320 and processor 322.

In the illustrative embodiments, the components in operating system 306 provide an infrastructure for an undo service that may be accessed by applications, such as applications 300 and Java applications 302. This service also may be accessed directly by user through a user interface provided in applications 300. Java applications 302 make calls to undo changes or restore a previous version of data to Java virtual machine 304. This virtual machine passes the call on to operating system 306.

The undo service in these examples is accessed through API calls to API layer 308. In this example, such a call is handled by operating system kernel 314. In other words, processes for the undo service of the present invention are located in operating system kernel 314. If the call is to generate a version of data, operating system kernel 314 stores data from physical memory 316 into a data store. A data store is a permanent storage for data. A data store is often located in a disk drive. This data store may be located in storage device 318. In response to receiving a call to store a version of data, operating system kernel 314 returns a version identifier to the caller. This identifier may take various forms. The identifier may be, for example, a time stamp or a numeric value. The manner in which the version of data is generated may be made using currently available snapshot mechanisms.

Data may be restored to a prior version through a call to the undo service accessed through API layer 308. In theses examples, the call includes the version identifier for the version of data that is to be restored. Additionally, versions of data may be stored on a periodic basis or in response to an event occurring without requiring the application to make a call to initiate the storing of the version.

In addition to storing data that may be located in physical memory 316, the mechanism of the present invention also stores other information that may be needed by an application that makes a call to restore data in physical memory 316 to a prior state. This other information includes, for example, prior versions of pages stored in a swap file, the state of device drivers, and the state of hardware devices accessed by device drivers.

In these depicted examples, operation system kernel 314 makes calls to resource managers such as virtual memory manager 310 and device drivers 312 to save information needed to properly store data to a prior version. Resource managers are software control systems for computer system resources, such as, for example, hard disk drives, keyboards, memory, graphics adapters, and printer. For example, a call may be made by an application to restore a document to a prior version. This prior version also may be associated with printer settings that are different from the current printer settings. These settings may be used to restore hardware, and the printer to its previous state in conjunction with restoring the document to its previous state. The mechanism of the present invention would make appropriate calls to device drivers 312 to restore the printer device driver and the printer itself to the state present at the time the prior version of the document was made. This information that is related to the data stored in memory is referred to as being co-dependent. Data is co-dependent, as used herein, when the data requires other data to be properly used.

Turning next to FIG. 4, a diagram illustrating components used to provide an undo service is depicted in accordance with a preferred embodiment of the present invention. In these illustrative examples, these undo services are located in operating system kernel 400. More specifically, this service may be implemented as versioning subsystem 402.

When save API call 404 is received from an application, versioning subsystem 402 saves information stored in the memory managed by memory management subsystem 406 into data stack 408. In these examples, versioning subsystem 402 takes a snapshot or copy of the memory and stores the data in data stack 408. This version of the data in the snapshot is associated with an index, which is returned to the caller that called save API call 404. In addition, versioning subsystem 402 makes calls to a virtual memory manager in memory manager subsystem 406 and to device drivers 410 to save other information needed to restore the data in the memory to the version stored in data stack 408. In theses examples, this other information is co-dependent information and includes, for example, pages stored in a swap file by the virtual memory manager, device driver state information, and hardware state information.

When restore API call 412 is made to operating system kernel 400, this call is handled by versioning subsystem 402 in these examples. A version identifier is identified from the call. This version identifier is employed by versioning subsystem 402 to restore a prior version of data from data stack 408 into the memory. Additionally, versioning subsystem 402 also may restore other state information, such as a state of pages, device drivers, and hardware. Versioning subsystem 402 accomplishes this restoration by making calls to the virtual memory manager and device drivers 410.

In this manner, the entire data processing system, including hardware peripherals, may be restored to a prior state. In these examples, different components within the operating system aid in managing information needed to restore the data processing system to a prior state.

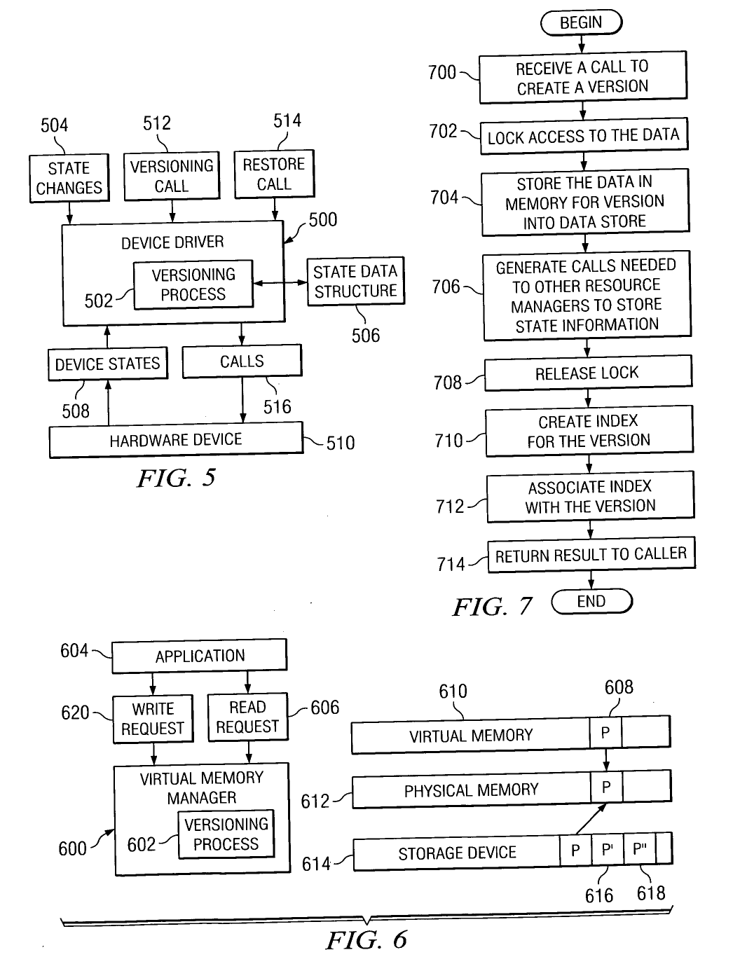

Turning next to FIG. 5, a diagram illustrating a device driver used to save state information is depicted in accordance with a preferred embodiment of the present invention. In this example, device driver 500 is an example of a device driver located in device drivers 312 in FIG. 3. In this example, device driver 500 includes versioning process 502. Versioning process 502 stores state changes 504 within state data structure 506. The illustrative examples show this process being initiated in response to a call from an operating system kernel. This process also may be initiated in response to calls from other sources, such as a hardware interrupt, a soft interrupt, and a device driver interface.

In these examples, state data structure 506 contains state information for device driver 500. Further, versioning process 502 also stores changes in device states 508 within state data structure 506. State data structure 506 may be a data store located in a hard disk drive.

State changes 504 include, for example, requests to change various parameters or settings for device driver 500. For example, these parameters or settings may include paper size, downloaded fonts, landscape mode, and print qualities. Changes in device state 508 are generally identified by a hardware device generating an interrupt, such as hardware device 510. One example is a caps lock button being depressed on a keyboard. Another example of a device state is a printer in a PCL print mode. Yet another example is whether a session is present on a network card. Other state information may include whether a valid connection is present and the speed of the connection of the network card. This state information for hardware device 510 is stored in state data structure 506 to allow hardware device 510 to be place or restored to a prior state at a later time.

In these examples, the state information from different state changes stored in state data structure 506 is used to create a version of state information. In other words, the state information contains all the information needed to return device driver 500 and/or hardware device 510 to a prior state. This version of the state information is associated with an identifier. In this manner, device driver 500 and/or hardware device 510 may be restored to a prior state.

All of the versions of data stored by versioning process 502 contain information to place device driver 500 and hardware device 510 in to some restorable state. A version identifier is associated with state information when versioning call 512 is received. In these examples, versioning call 512 is received from a versioning subsystem, such as versioning subsystem 402 in FIG. 4.

When restore call 514 is received, versioning process 502 identifies a version identifier from this call. In these examples, the call is made by versioning subsystem 402 in FIG. 4, and the version identifier takes the form of a time stamp. The data or version of data associated with the version identifier is located in state data structure 506. This information is used to place device driver 500 back to a prior state. For example, a configuration data for device driver 500 is restored to the prior state. This configuration may include various printer settings such as paper type and printing quality when hardware device 510 is a printer.

Additionally, the state information data in state data structure 506 is used to restore hardware device 510 to the prior state. For example, if hardware device 510 is a printer and the prior state was a PCL print mode, calls 516 may be made to hardware device 510. Calls 516 may include, for example, a call to reset hardware device 510 to this particular print mode. If hardware device 510 takes the form of a network card, the state information may include, in this example, whether a valid connection was present at that time and the speed of the connection. In this case, versioning process 502 generates calls 516 to place hardware device 510 back into the previous state. These calls may include, for example, calls needed to set up the connection in its prior state. In the instance in which hardware device 510 is a keyboard, signals may be sent to set features such as caps lock or number lock into the state present at the time the version was made.

Turning to FIG. 6, a diagram illustrating a virtual memory manager used to save state information is depicted in accordance with a preferred embodiment of the present invention. As illustrated, virtual memory manager 600 is part of a paged memory system. This type of memory system is one that uses sections of memory called pages, which are swapped in and out of physical memory. In this depicted example, virtual memory manager 600 contains versioning process 602. Application 604 may send read request 606 to virtual memory manager 600 to access page P 608 in virtual memory 610. Virtual memory 610 provides a simulation to provide more memory than physically exists. As many pages as possible are place in to physical memory 612. Other pages are stored in a swap file in a data store, which may be located in storage device 614. A swap file is a file on a permanent storage, also called a data store. This swap file is used to hold pages that cannot be stored in a physical memory.

Normally read request 606 is a request for a page, such as page P 608 in virtual memory 610. If page P 608 is not present in physical memory 612, the page has been swapped out or placed in to a swap file in storage device 614. Page P 608 is retrieved from storage device 614 and placed in to physical memory 612 for use.

In this illustrative example, versioning process 602 checks read request 606 to determine whether an “overload” has occurred. An overload occurs if an argument, such as a version identifier or some other parameter, has been added to indicate that a different function should occur. An argument may be added to read request 606 to use a different version of the function used to retrieve pages from a swap file in a storage device, such as storage device 614. If an additional argument has been added, versioning process 602 uses the argument to identify another version of page P 608, such as page P′ 616 or page P″ 618. If one of these other versions of the page is identified by the additional argument, versioning process 602 places that identified page into physical memory 612 in place of page P 608.

A new version of a page, such as page P 608 may be generated in response to write request 620. When write request 620, containing an additional argument, is received by virtual memory manager 600, versioning process 602 stores the current version of page P 608 in storage device 614 before writing the new page into physical memory 612.

Versions of pages may be made based on different events. For example, the version may be made every time a write request occurs. Alternatively, this version may be made periodically. The version may be made before or after the write to the page occurs, depending on the particular implementation. For example, the version may be made after a change to the page occurs. If a page is initialized with content, and then the content is changed, the changed content is stored as a version. Alternatively, the version is recorded before the change. In this illustrative implementation, when current content is changed to new content, the current content is stored before the change is made.

The calls to read and write different versions of pages may be made by versioning subsystem 402 in FIG. 4. These calls also may be made by applications directly, depending on the implementation. In this manner, versioning process 602 in virtual memory manager 600 allows for different versions of pages to be restored for use in restoring data processing system to a prior state. These different versions of the pages are used in conjunction with other store and restore features described herein to provide an infrastructure for API based undo functions.

Turning next to FIG. 7, a flowchart of a process for storing a version of data is depicted in accordance with a preferred embodiment of the present invention. The process illustrated in FIG. 7 may be implemented in an operating system kernel, such as operating system kernel 400 in FIG. 4. In particular, this process may be implemented in a versioning subsystem, such as versioning subsystem 402 in FIG. 4.

The process begins by receiving a call to create a version (step 700). In response to receiving the call, the access to the data is locked to prevent changes to the data until the version or snapshot of the data is made (step 702). The data in the memory is stored in a data store (step 704). Thereafter, calls are made to resource managers to store state information (step 706). This state information is information that is needed to return the entire data processing system to a particular state. This information may include the state of hardware devices such as, adapters or peripherals. These adapters may be, for example, a graphics adapter or a network adapter. Peripherals include, for example, a printer, a display device, a keyboard, and a mouse.

After the other resource managers have stored state information, the lock on the data is released (step 708). An index in the form of a version identifier is created for the version of data placed in to the data store (step 710). This index may be, for example, a time stamp or a numerical value. The index is then associated with the version of data (step 712). The result is then returned to the caller (step 714) with the process terminating thereafter.

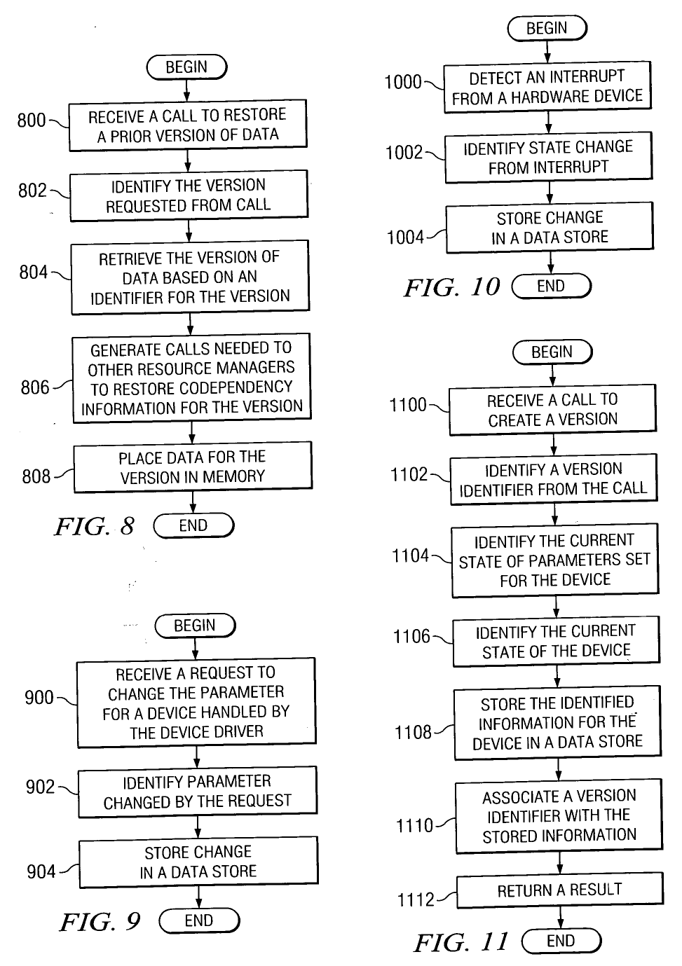

Turning now to FIG. 8, a flowchart of a process for restoring a prior version of data is depicted in accordance with a preferred embodiment of the present invention. The process illustrated in FIG. 8 may be implemented in an operating system kernel, such as operating system kernel 400 in FIG. 4. In particular, this process may be implemented in a versioning subsystem, such as versioning subsystem 402 in FIG. 4.

The process begins by receiving a call to restore a prior version of data (step 800). Next, the version of data requested from the call is identified (step 802). The version of data is retrieved from a data store based on the identifier (step 804). Calls are generated to other resource managers to restore co-dependant information for the version (step 806). The co-dependant information includes, for example, restoring virtual memory and hardware to a prior state. The data retrieved from the data store for the version is placed in to memory (step 808) with the process terminating thereafter.

With reference next to FIG. 9, a flowchart of a process in a device driver for saving state information is depicted in accordance with a preferred embodiment of the present invention. The process illustrated in FIG. 9 may be implemented in an operating system, such as operating system 306 in FIG. 3. In particular, this process may be implemented in a versioning process, such as versioning process 502 in FIG. 5.

The process begins by receiving a request to change the parameter for a device handled by the device driver (step 900). This parameter may be, for example, a color or font type to be displayed by a graphics adapter. The device driver then identifies the parameter changed by the request (step 902). Once the device driver has identified the parameter changed by the request, the change is then stored in a data store (step 904) with the process terminating thereafter.

With reference to FIG. 10, a flowchart of a process in a device driver for saving state information is depicted in accordance with a preferred embodiment of the present invention. The process illustrated in FIG. 10 may be implemented in an operating system, such as operating system 306 in FIG. 3. In particular, this process may be implemented in a versioning process, such as versioning process 502 in FIG. 5.

The process begins by detecting an interrupt from a hardware device handled by the device driver (step 1000). Next, the state change in the hardware device is identified from the interrupt (step 1002). The state change may be identified from the interrupt identifier received with the interrupt. This change is stored in a data store (step 1004) with the process terminating thereafter.

With reference next to FIG. 11, a flowchart of a process in a device driver for saving state information is depicted in accordance with a preferred embodiment of the present invention. The process illustrated in FIG. 11 may be implemented in an operating system, such as operating system 306 in FIG. 3. In particular, this process may be implemented in a versioning process, such as versioning process 502 in FIG. 5.

The process begins by receiving a call to create a version (step 1100). In these examples, the call is received from a process or component, such as versioning subsystem 402 in FIG. 4. This call is received as part of a process for creating a version of data or a snapshot for the data processing system. A version identifier is then identified from the call (step 1102). The versioning subsystem includes a version identifier to identify co-dependant information stored by the device driver.

The current state of the parameters set for the device is then identified (step 1104) followed by identifying the current state of the device (step 1106). The state information in steps 1104 and 1106 are identified in a data store. This information is generated using processes described in FIGS. 9 and 10.

The identified information for the device is then stored in a data store (step 1108). A version identifier is then associated with the stored information (step 1110). A result is returned (step 1112), thus terminating the process. This result is returned to the caller of the process such as a versioning subsystem. In this manner, a device driver may generate versioning information for use in restoring portions of a data processing system to a prior state. In these examples, these portions include the device driver itself and the hardware device or devices managed by the device driver.

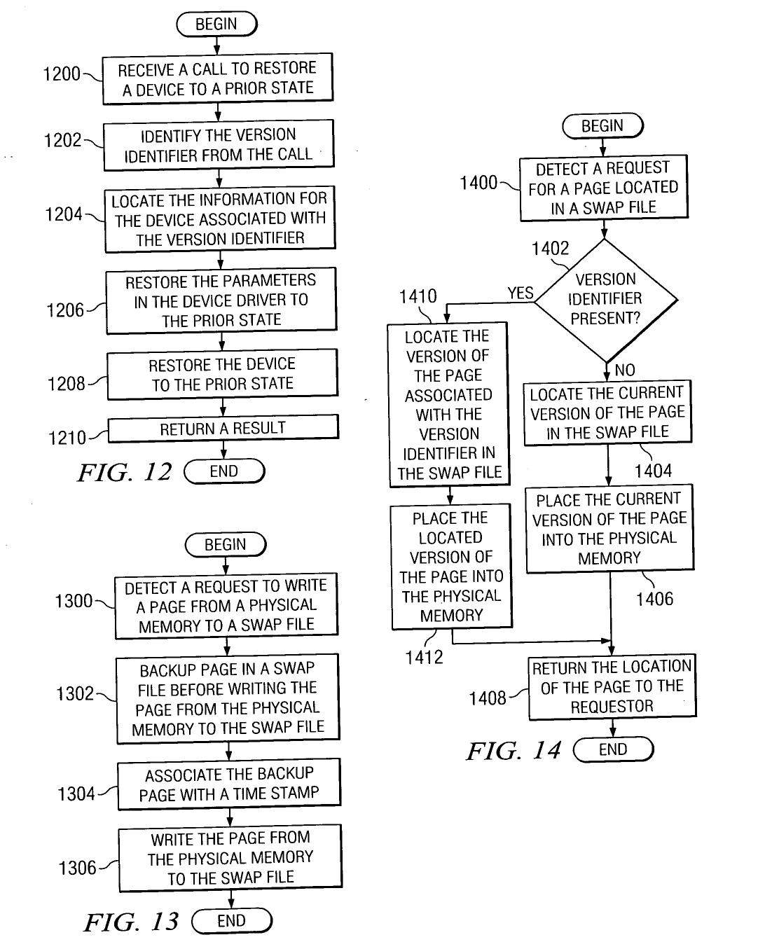

Turning to FIG. 12, a flowchart of a process in a device driver for restoring state information is depicted in accordance with a preferred embodiment of the present invention. The process illustrated in FIG. 12 may be implemented in an operating system, such as operating system 306 in FIG. 3. In particular, this process may be implemented in a versioning process, such as versioning process 502 in FIG. 5.

The process begins by receiving a call to restore a device to a prior state (step 1200). The call is received from a caller, such as versioning subsystem 402 in FIG. 4. The version identifier is then identified from the call (step 1202). This version identifier is placed in the call by the caller to locate co-dependant information needed to restore the data processing system to a prior state. The information for the device associated with the version identifier is then located (step 1204). In these examples, this information is found in a data store, such as a hard disk drive. The parameters in the device driver are restored to the prior state (step 1206). The device is restore to the prior state (step 1208). Step 1208 includes making calls to the hardware device to restore the device to the prior state. In some cases, this process may include resetting or restarting the hardware device and then sending calls to set the device to the prior state.

A result is then returned (step 1210) with the process terminating thereafter. This result is returned to the caller. In some cases, a failure may be returned if the hardware device cannot be reset or restored to the prior state.

Turning to FIG. 13, a flowchart of a process in a virtual memory manager for storing versions of pages is depicted in accordance with a preferred embodiment of the present invention. The process illustrated in FIG. 13 may be implemented in an operating system, such as operating system 306 in FIG. 3. In particular, this process may be implemented in a virtual memory manager, such as virtual memory manager 600 in FIG. 6.

The process begins by detecting a request to write a page from a physical memory to a swap file (step 1300). This request occurs when not enough room is present in the physical memory. The page is then backed up in the swap file before writing the page from physical memory to the swap file (step 1302). In step 1302, a copy of the page is made in the swap file to form a version of the page. Depending on the particular implementation, this version of the page may be stored in another file or location. The version of the page is associated with the time stamp (step 1304). The current page in physical memory is then written from the memory to the swap file (step 1306) with the process terminating thereafter.

Turning to FIG. 14, a flowchart of a process in a virtual memory manager for retrieving pages from a swap file is depicted in accordance with a preferred embodiment of the present invention. The process illustrated in FIG. 14 may be implemented in an operating system, such as operating system 306 in FIG. 3. In particular, this process may be implemented in a virtual memory manager, such as virtual memory manager 600 in FIG. 6.

The process begins by detecting a request for a page located in a swap file (step 1400). This request occurs when an application requests a page in virtual memory that is not actually present in the physical memory. In response to detecting this request, a determination is made as to whether a version identifier is present in the request (step 1402). In this example, the version identifier is considered an additional argument or parameter that may be used to initiate a different version of a function. With respect to the virtual memory manager, this different version of the function allows for a prior version of a page to be placed in the physical memory, rather than the current version.

If the version identifier is not present, the current version of the page in the swap file is located (step 1404). This current version of the page is then placed into physical memory (step 1406). The location of this page is then returned to the requester (step 1408) with the process terminating thereafter.

With reference again to step 1402, if a version identifier is present, the version of the page associated with the version identifier is located in the swap file (step 1410). This located version of the page is then place into the physical memory (step 1412) with the process then proceeding to step 1408 as described above.

Thus, the present invention provides an improved method, apparatus, and computer instructions for restoring a data processing system to a prior state. The mechanism of the present invention includes an infrastructure for an undo service that may be called from an application layer via an API layer. The mechanism of the present invention also provides an infrastructure to store and restore co-dependant information. In the illustrative examples, the co-dependant information is used to place components, such as hardware devices, device drivers, and swap files in a prior state.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a virtual memory manager for managing data in a paged memory system, the method comprising:
responsive to receiving a request to write a page of data in the paged memory system, writing the page;
responsive to receiving the request to write the page of data in the paged memory system, creating a version of the page; and
associating a version identifier with the version of the page.

2. The method of claim 1, wherein the writing step comprises:
writing the page after creating the version of the page.

3. The method of claim 1, wherein the writing step comprises:
writing the page prior to creating the version of the page.

4. The method of claim 1, wherein the request is received from a requester and further comprising:
returning the version identifier to the requestor

5. The method of claim 1 further comprising:
responsive to receiving a subsequent request to retrieve a page into physical memory from a data store, determining whether the subsequent request includes a specific version identifier;
responsive to the subsequent request including the version identifier, locating a version of the page corresponding to the specific version identifier to form a prior page; and
placing the prior page into the physical memory.

6. The method of claim 4 further comprising:
responsive to the subsequent request excluding the version identifier, locating the page; and
placing the page into the physical memory.

7. The method of claim 1, wherein the request is received from an operating system kernel.

8. The method of claim 5, wherein the data store is a swap file.

9. A data processing system in a virtual memory manager for managing data in a paged memory system, the data processing system comprising:
writing means, responsive to receiving a request to write a page of data in the paged memory system, for writing the page;
creating means, responsive to receiving the request to write the page of data in the paged memory system, for creating a version of the page; and
associating means for associating a version identifier with the version of the page.

10. The data processing system of claim 9, wherein the writing means comprises:
means for writing the page after creating the version of the page.

11. The data processing system of claim 9, wherein the writing means comprises:
means for writing the page prior to creating the version of the page.

12. The data processing system of claim 9, wherein the request is received from a requester and further comprising:
returning means for returning the version identifier to the requester.

13. The data processing system of claim 9 further comprising:
determining means, responsive to receiving a subsequent request to retrieve a page into physical memory from a data store, for determining whether the subsequent request includes a specific version identifier;
locating means, responsive to the subsequent request including the version identifier, for locating a version of the page corresponding to the specific version identifier to form a prior page; and
placing means for placing the prior page into the physical memory.

14. The data processing system of claim 12 further comprising:
locating means, responsive to the subsequent request excluding the version identifier, for locating the page; and
placing means for placing the page into the physical memory.

15. The data processing system of claim 9, wherein the request is received from an operating system kernel.

16. The data processing system of claim 13, wherein the data store is a swap file.

17. A computer program product in a virtual memory manager for managing data in a paged memory system, the computer program product comprising:
first instructions, responsive to receiving a request to write a page of data in the paged memory system, for writing the page;
second instructions, responsive to receiving the request to write the page of data in the paged memory system, for creating the version of the page; and
third instructions for associating a version identifier with the version of the page.

18. The computer program product of claim 17, wherein the first instructions comprises:
sub instructions for writing the page after creating the version of the page.

19. The computer program product of claim 17, wherein the first instructions comprises:
sub instructions for writing the page prior to creating the version of the page.

20. The computer program product of claim 17, wherein the request is received from a requester and further comprising:
fourth instructions for returning the version identifier to the requester.

21. The computer program product of claim 17 further comprising:
fourth instructions, responsive to receiving a subsequent request to retrieve a page into physical memory from a data store, for determining whether the subsequent request includes a specific version identifier;
fifth instructions, responsive to the subsequent request including the version identifier, for locating a version of the page corresponding to the specific version identifier to form a prior page; and
sixth instructions for placing the prior page into the physical memory.

22. The computer program product of claim 20 further comprising:
fifth instructions, responsive to the subsequent request excluding the version identifier, for locating the page; and
sixth instructions for placing the page into the physical memory.

23. The computer program product of claim 17, wherein the request is received from an operating system kernel.

24. The computer program product of claim 21, wherein the data store is a swap file.
